(19) United States
(12) Patent Application Publication
(10) Pub. No.: US 2026/0311505 A1
(43) Pub. Date: Oct. 8, 2026

(54) PROXIMITY-BASED CONTROL OF AN APPLIANCE

(71) Applicant: Haier US Appliance Solutions, Inc., Wilmington, DE (US)

(72) Inventor: Michael Goodman Schroeder, Crestwood, KY (US)

(21) Appl. No.: 19/098,170

(22) Filed: Apr. 2, 2025

(51) Int. Cl. G06V 40/10; F25D 29/00; G06T 7/194; G06T 7/20; G06T 7/50; G06T 7/70

(52) U.S. Cl. CPC G06V 40/10; F25D 29/00; G06T 7/194; G06T 7/20; G06T 7/50; G06T 7/70; F25D 2700/04; G06T 2207/30196

(57) ABSTRACT

A method of operating an appliance, the appliance including a cabinet and a camera, the method including obtaining one or more images using the camera, analyzing the one or more images to identify a proximity or posture of a user, determining that the user wishes to interact with the appliance based at least in part on the proximity or the posture of the user, and adjusting interaction parameters of the appliance in response to determining that the user wishes to interact with the appliance.

### FIELD OF THE INVENTION

The present subject matter relates generally to appliances, and more particularly to methods of operating an appliance by detecting user interactions and/or proximity.

### BACKGROUND OF THE INVENTION

Conventional appliances include user interface panels where a user may interact with the appliance. For example, refrigerator appliances include user interface panels where a user can adjust operating parameters, provide commands, update inventory lists, or otherwise interact with the appliance. However, in certain situations, a user may not wish to interact with these user interface panels directly, e.g., when they are not directly in front of the appliance, when their hands are occupied, when they are busy with other tasks, etc.

Certain conventional appliances include features for facilitating improved user interactions. For example, conventional appliances utilize “wake words,” i.e., words that are detected by the appliance and that initiate a process of listening for commands or requests. These wake words are often clunky, require user training and behavior changes, and do not follow typical conversational interactions. Accordingly, appliances often respond erratically, e.g., by providing a response or initiating a task when the user did not intend to take such action, or vice versa. This inability to naturally communicate and control an appliance may lead to user frustration, performance of unintended tasks, failure to perform intended tasks, etc. In addition, these methods of detecting a user’s desire to interact often generate false triggers and user frustration.

Accordingly, consumer appliances with features that facilitate improved interaction would be useful. More specifically, appliances that can accurately detect a user’s desire to interact and that facilitate a more casual interaction without the need for wake words would be particularly beneficial.

### BRIEF DESCRIPTION OF THE INVENTION

Aspects and advantages of the invention will be set forth in part in the following description, may be apparent from the description, or may be learned through practice of the invention.

In one exemplary embodiment, an appliance is provided including a cabinet, a camera, and a controller in operative communication with the camera. The controller is being configured to obtain one or more images using the camera, analyze the one or more images to identify a proximity or posture of a user, determine that the user wishes to interact with the appliance based at least in part on the proximity or the posture of the user, and adjust interaction parameters of the appliance in response to determining that the user wishes to interact with the appliance.

In another exemplary embodiment, a method of operating an appliance is provided. The appliance includes a cabinet and a camera. The method includes obtaining one or more images using the camera, analyzing the one or more images to identify a proximity or posture of a user, determining that the user wishes to interact with the appliance based at least in part on the proximity or the posture of the user, and adjusting interaction parameters of the appliance in response to determining that the user wishes to interact with the appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to an example embodiment of the present subject matter.

FIG. 2 provides a front view of the example refrigerator appliance of FIG. 1, with the doors of the fresh food chamber and freezer chamber shown in an open position.

FIG. 3 provides a method for operating an appliance according to an example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Aspects of the present subject matter are generally directed to a smart refrigerator appliance integrated with an external camera equipped with an advanced background subtraction algorithm to continuously detect and track people as they approach the refrigerator appliance. Once a person reaches a defined threshold in size (e.g., measured either in pixels, height, etc.), the refrigerator appliance identifies them as being nearby, triggering the activation of additional features. These features may include automatic door opening, voice-activated dispensing, general voice command response, more natural language interaction without requiring a wake word, etc. This system enhances user convenience by making the fridge more intuitive and responsive to user presence.

Aspects of the present subject matter are designed to make interactions with the refrigerator appliance as effortless as possible, particularly for users who may have their hands full or prefer a more hands-free experience. The use of background subtraction for precise tracking ensures that the fridge only responds when necessary, reducing unnecessary activations and focusing on genuine user needs. By incorporating these features, the smart refrigerator appliance becomes more than just a household appliance—it transforms into an intelligent, responsive assistant that adapts to the user's presence and commands, creating a more intuitive and user-friendly kitchen environment. Also, conventional presence sensors may be removed or supplemented on models with an external camera.

According to an example embodiment, the smart refrigerator fridge integrates an external camera that detects the person and tracks them in real-time, and their size is measured either in pixels or height. Once the system determines that the person has exceeded a predefined threshold, indicating close proximity, it categorizes them as nearby. This may also by predicated on the user facing the appliances. Upon recognizing a nearby user, the fridge may unlock a range of advanced features designed to enhance convenience and user experience.

An example of advanced features may include automatic door opening, i.e., the fridge door can automatically open when a user is detected as being close enough, especially useful if they are holding items and cannot easily open the door manually. In addition, the push to open feature can be unlocked or have the threshold reduced for detecting a push. This eliminates most false triggering while allowing the door to respond to a very light touch. The refrigerator appliance may use one or more mechanical actuators to facilitate door movements.

An example of advanced features may include voice-activated dispensing, i.e., the fridge allows for voice-controlled dispensing of water or ice. Users can simply ask for a specific amount of water or ice, and the fridge will comply without requiring physical interaction. It may be undesirable to unlock this sort of feature without confirmation that a user is in position. This may also require the presence detection of a cup in the dispenser recess.

An example of advanced features may include general voice command responses, i.e., in addition to dispensing, the fridge can respond to a broader range of voice commands. This could include setting reminders, adding items to a shopping list, or providing information about the contents of the fridge.

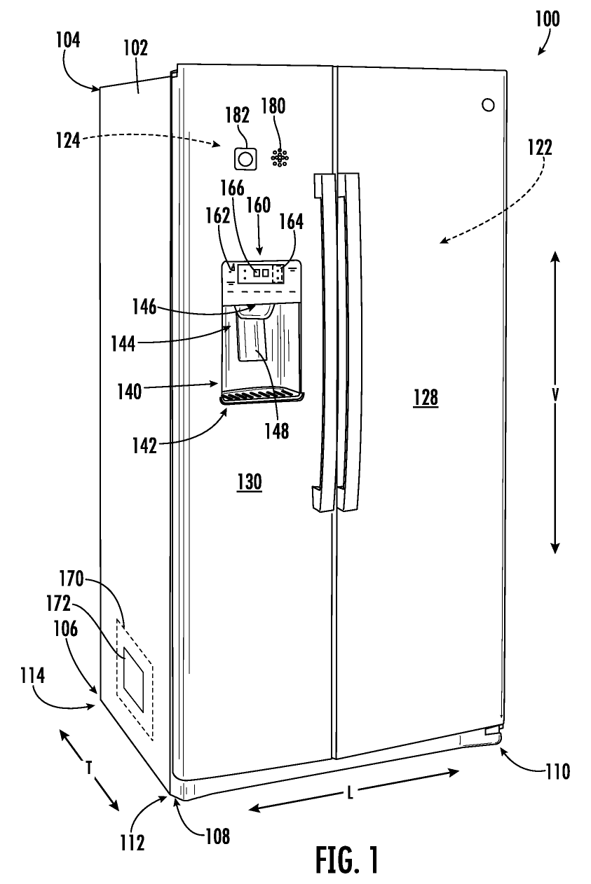

FIG. 1 provides a perspective view of a refrigerator appliance 100 according to an exemplary embodiment of the present subject matter. Refrigerator appliance 100 includes a cabinet or housing 102 that extends between a top 104 and a bottom 106 along a vertical direction V, between a first side 108 and a second side 110 along a lateral direction L, and between a front side 112 and a rear side 114 along a transverse direction T. Each of the vertical direction V, lateral direction L, and transverse direction T are mutually perpendicular to one another.

Housing 102 defines chilled chambers for receipt of food items for storage. In particular, housing 102 defines fresh food chamber 122 positioned at or adjacent second side 110 of housing 102 and a freezer chamber 124 arranged at or adjacent first side 108 of housing 102. As such, refrigerator appliance 100 is generally referred to as a side-by-side refrigerator. It is recognized, however, that the benefits of the present disclosure apply to other types and styles of refrigerator appliances such as, e.g., a top mount refrigerator appliance, a bottom mount refrigerator appliance, or a single door refrigerator appliance. Consequently, the description set forth herein is for illustrative purposes only and is not intended to be limiting in any aspect to any particular refrigerator chamber configuration.

A refrigerator door 128 is rotatably hinged to an edge of housing 102 for selectively accessing fresh food chamber 122. In addition, a freezer door 130 is rotatably hinged to an edge of housing 102 for selectively accessing freezer chamber 124. Refrigerator door 128 and freezer door 130 are shown in the closed configuration in FIG. 1. One skilled in the art will appreciate that other chamber and door configurations are possible and within the scope of the present invention.

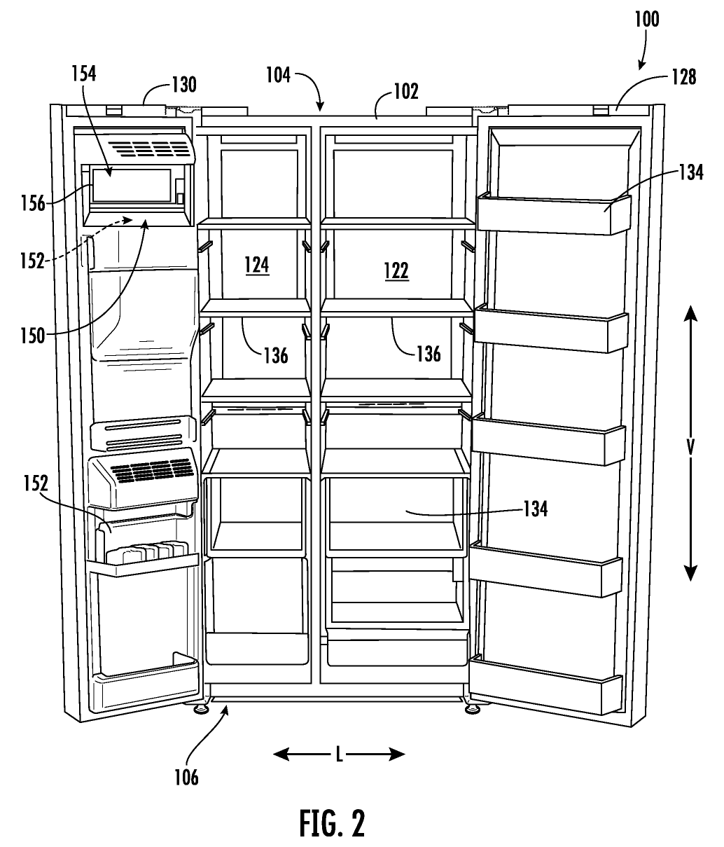

FIG. 2 provides a front view of refrigerator appliance 100 shown with refrigerator door 128 and freezer door 130 in the open position. As shown in FIG. 2, various storage components are mounted within fresh food chamber 122 to facilitate storage of food items therein as will be understood by those skilled in the art. In particular, the storage components may include bins 134 and shelves 136. Each of these storage components are configured for receipt of food items (e.g., beverages and/or solid food items) and may assist with organizing such food items. As illustrated, bins 134 may be mounted on refrigerator door 128 and freezer door 130 or may slide into a receiving space in fresh food chamber 122 or freezer chamber 124. It should be appreciated that the illustrated storage components are used only for the purpose of explanation and that other storage components may be used and may have different sizes, shapes, and configurations.

Referring now generally to FIG. 1, a dispensing assembly 140 will be described according to exemplary embodiments of the present subject matter. Dispensing assembly 140 is generally configured for dispensing liquid water and/or ice. Although an exemplary dispensing assembly 140 is illustrated and described herein, it should be appreciated that variations and modifications may be made to dispensing assembly 140 while remaining within the present subject matter.

Dispensing assembly 140 and its various components may be positioned at least in part within a dispenser recess 142 defined on freezer door 130. In this regard, dispenser recess 142 is defined on a front side 112 of refrigerator appliance 100 such that a user may operate dispensing assembly 140 without opening freezer door 130. In addition, dispenser recess 142 is positioned at a predetermined elevation convenient for a user to access ice and enabling the user to access ice without the need to bend-over. In the exemplary embodiment, dispenser recess 142 is positioned at a level that approximates the chest level of a user.

Dispensing assembly 140 includes an ice dispenser 144 including a discharging outlet 146 for discharging ice from dispensing assembly 140. An actuating mechanism 148, shown as a paddle, is mounted below discharging outlet 146 for operating ice or water dispenser 144. In alternative exemplary embodiments, any suitable actuating mechanism may be used to operate ice dispenser 144. For example, ice dispenser 144 can include a sensor (such as an ultrasonic sensor) or a button rather than the paddle. Discharging outlet 146 and actuating mechanism 148 are an external part of ice dispenser 144 and are mounted in dispenser recess 142.

Referring again to FIG. 2, inside refrigerator appliance 100, freezer door 130 may include an ice dispensing system 150 that generally includes one or more icemakers and ice storage bins 152 that are configured to form ice. In this regard, for example, ice dispensing system 150 may define an ice making chamber 154 for housing ice making assemblies, storage mechanisms, and dispensing mechanisms. According to the illustrated embodiment, ice dispensing system 150 may include dispensing assembly 140 and may have a main icemaker 156. In addition, ice dispensing system 150 may include an icemaker for forming “craft ice” that is commonly large, clear cubes or spheres of ice for alcoholic or non-alcoholic drinks. For example, a user may access this craft ice by opening freezer door 130 and accessing storage bin 152 directly.

A control panel 160 is provided for controlling the mode of operation. For example, control panel 160 includes one or more selector inputs 162, such as knobs, buttons, touchscreen interfaces, etc., such as a water dispensing button and an ice-dispensing button, for selecting a desired mode of operation such as crushed or non-crushed ice. In addition, inputs 162 may be used to specify a fill volume or method of operating dispensing assembly 140. In this regard, inputs 162 may be in communication with a processing device or controller 164. Signals generated in controller 164 operate refrigerator appliance 100 and dispensing assembly 140 in response to selector inputs 162. Additionally, a display 166, such as an indicator light or a screen, may be provided on control panel 160. Display 166 may be in communication with controller 164 and may display information in response to signals from controller 164.

As used herein, “processing device” or “controller” may refer to one or more microprocessors or semiconductor devices and is not restricted necessarily to a single element. The processing device can be programmed to operate refrigerator appliance 100 and dispensing assembly 140. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

Referring again briefly to FIG. 1, according to an exemplary embodiment, cabinet 102 also defines a mechanical compartment 170 at or near the bottom 106 of the cabinet 102 for receipt of a hermetically sealed cooling system 172. In general, sealed cooling system 172 is configured for transporting heat from the inside of refrigerator appliance 100 to the outside (e.g., by executing a vapor-compression cycle or another suitable refrigeration cycle). As is generally understood by those of skill in the art, the hermetically sealed system 172 contains a working fluid, e.g., refrigerant, which flows between various heat exchangers of the sealed system 172 where the working fluid changes phases while transferring thermal energy.

In this regard, as understood by one having ordinary skill in the art, sealed system 172 may include a compressor, a condenser, an expansion device, and one or more evaporators connected in series by a fluid conduit that is charged with a refrigerant. Within sealed system 172, refrigerant flows into the compressor, which operates to increase the pressure of the refrigerant. This compression of the refrigerant raises its temperature, which is lowered by passing the refrigerant through the condenser. Within the condenser, heat exchange with ambient air takes place so as to cool the refrigerant. A condenser fan may be used to pull air across the condenser, so as to provide forced convection for a more rapid and efficient heat exchange between the refrigerant within the condenser and the ambient air. Thus, as will be understood by those skilled in the art, increasing air flow across the condenser can, e.g., increase the efficiency of the condenser by improving cooling of the refrigerant contained therein.

An expansion device (e.g., an electronic expansion valve, capillary tube, or other restriction device) receives refrigerant from the condenser. From the expansion device, the refrigerant enters the evaporator. Upon exiting the expansion device and entering the evaporator, the refrigerant drops in pressure. Due to the pressure drop and/or phase change of the refrigerant, the evaporator is relatively cool. An evaporator fan is typically provided at each the evaporator, e.g., to force air across and around the at least one evaporator to transfer thermal energy from the air to the evaporator (and more particularly, to the working fluid or refrigerant therein).

In this manner, a flow of cooling air exits the evaporator and may be distributed to one or more of the chilled chambers 122 and/or 124. Specifically, one or more ducts may extend between the mechanical compartment 170 and the chilled chambers 122 and/or 124 to provide fluid communication therebetween, e.g., to provide the chilled air from the hermetically sealed cooling system 172, e.g., from an evaporator thereof, to one or more of the chilled chambers 122 and/or 124.

The sealed system 172 described herein is provided by way of example only. Thus, it is within the scope of the present subject matter for other configurations of the refrigeration system to be used as well. For example, according to alternative embodiments, sealed system 172 may include additional components, e.g., at least one additional evaporator, compressor, expansion device, and/or condenser. For example, refrigerator appliance 100 may have two or more split evaporators, e.g., one dedicated primarily to cooling fresh food chamber 122 and one dedicated primarily to cooling freezer chamber 124. In addition, alternative plumbing configurations, valves, and flow regulators may be used to route refrigerant throughout sealed system 172.

As illustrated in FIG. 1, refrigerator appliance 100 may further include one or more microphones 180 that are generally positioned and configured for monitoring sound around refrigerator appliance 100, e.g., within the room containing refrigerator appliance 100. For example, according to the illustrated embodiment, a single microphone 180 is mounted to refrigerator door 128 of refrigerator appliance 100. Microphone 180 is generally configured for monitoring sound, voice inputs from the user of refrigerator appliance 100, etc. As used herein, the terms microphone and the like are generally intended to refer to any suitable audio input, such as a microphone, an acoustic pickup, sound receiver/transmitter, or any of sound receiving device.

In addition, it should be appreciated that any suitable number, type, position, and configuration of microphones may be used while remaining within the scope of the present subject matter. For example, according to the illustrated embodiment, a single microphone 180 is mounted to refrigerator door 128 for monitoring sounds and voices around refrigerator appliance 100 (e.g., within the kitchen, dining room, etc.). As described herein, detected sounds and voices may be used to improve user interaction and control of refrigerator appliance 100. However, according to alternative embodiments, microphone 180 could be mounted to any other kitchen appliance or could be a standalone device that is in operative communication with refrigerator appliance 100 to provide feedback regarding a user interaction with refrigerator appliance 100.

As shown for example in FIG. 1, refrigerator appliance 100 may include a camera 182 that is generally positioned and configured for obtaining images of the environment surrounding refrigerator appliance 100 during operation. Specifically, according to the illustrated embodiment, a single camera 182 may be mounted to refrigerator door 128 or at any other suitable position for obtaining images in or around refrigerator appliance 100. Although a single camera 182 is illustrated, it should be appreciated that refrigerator appliance 100 may include any suitable number of cameras positioned at any suitable location and orientation for obtaining useful images related to user interaction with refrigerator appliance 100. In addition, it should be appreciated that each camera 182 may include features for adjusting the field-of-view and/or orientation.

It should be appreciated that the images obtained by camera 182 may vary in number, frequency, angle, resolution, detail, etc. in order to improve the clarity of the particular regions surrounding or within refrigerator appliance 100. In addition, according to exemplary embodiments, controller 164 (or any other suitable dedicated controller) may be communicatively coupled to camera 182 and may be programmed or configured for analyzing the images obtained by camera 182, e.g., in order to detect and analyze user interactions with refrigerator appliance. Moreover, it should be appreciated that controller 164 may be in operative communication with a remote server (e.g., via a network) for offloading images for remote analysis. Such analysis may be intended to detect user interactions with refrigerator appliance 100, e.g., as described in more detail below.

Now that the construction and configuration of refrigerator appliance 100 has been presented according to an exemplary embodiment of the present subject matter, an exemplary method 200 for operating a refrigerator appliance 100 is provided. Method 200 can be used to operate refrigerator appliance 100, or to operate any other suitable refrigerator. In this regard, for example, controller 164 may be configured for implementing method 200. However, it should be appreciated that the exemplary method 200 is discussed herein only to describe exemplary aspects of the present subject matter and is not intended to be limiting.

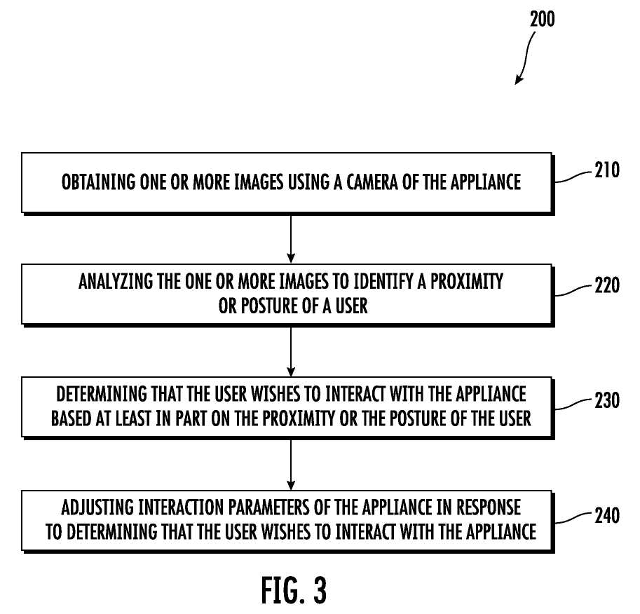

Referring now to FIG. 3, method 200 includes, at step 210, obtaining one or more images using a camera of the appliance. In this regard, continuing the example from above, camera 182 of refrigerator appliance 100 may obtain images of the environment surrounding refrigerator appliance 100. Although step 210 is described herein as obtaining one or more images, it should be appreciated that obtaining these images may include obtaining more than one image, a series of frames, a video, or any other suitable visual representation of the environment surrounding refrigerator appliance 100 using camera 182. In addition, it should be appreciated that the images obtained by camera 182 may vary in number, frequency, angle, resolution, detail, etc. in order to improve the clarity of the images obtained. The obtained images may also be cropped in any suitable manner for improved focus on desired portions of the images.

Step 220 includes analyzing the one or more images to identify a proximity or posture of a user. In this regard, for example, controller 164 may be programmed to analyze the images and assess the proximity of the user, e.g., to facilitate a determination of whether the user is intending to interact with the appliance. In addition, or alternatively, controller 164 may be programmed to analyze the images and assess the posture of the user, e.g., to facilitate a determination of whether the user is intending to interact with the appliance. Examples of such analysis are provided below, but it should be appreciated that these examples are not intended to limit the subject matter in any manner.

According to exemplary embodiments, this image analysis may use any suitable image processing technique, image recognition process, etc. As used herein, the terms “image analysis” and the like may be used generally to refer to any suitable method of observation, analysis, image decomposition, feature extraction, image classification, etc. of one or more images, videos, or other visual representations of an object. As explained in more detail below, this image analysis may include the implementation of image processing techniques, image recognition techniques, or any suitable combination thereof. In this regard, the image analysis may use any suitable image analysis software or algorithm to constantly or periodically monitor for the presence of a user. It should be appreciated that this image analysis or processing may be performed locally (e.g., by controller 164) or remotely (e.g., by offloading image data to a remote server or network).

Specifically, the analysis of the one or more images may include implementation an image processing algorithm. As used herein, the terms “image processing” and the like are generally intended to refer to any suitable methods or algorithms for analyzing images that do not rely on artificial intelligence or machine learning techniques (e.g., in contrast to the machine learning image recognition processes described below). For example, the image processing algorithm may rely on image differentiation, e.g., such as a pixel-by-pixel comparison of two sequential images. This comparison may help identify substantial differences between the sequentially obtained images, e.g., to identify movement, the presence of a particular object, the existence of a certain condition, etc. For example, one or more reference images may be obtained when a particular condition exists, and these references images may be stored for future comparison with images obtained during appliance operation. Similarities and/or differences between the reference image and the obtained image may be used to extract useful information for improving appliance performance. For example, controller 164 may be trained on image of the surroundings (e.g., the kitchen) when no user is present and may use an image differentiation algorithm to isolate the user.

According to exemplary embodiments, image processing may include blur detection algorithms that are generally intended to compute, measure, or otherwise determine the amount of blur in an image. For example, these blur detection algorithms may rely on focus measure operators, the Fast Fourier Transform along with examination of the frequency distributions, determining the variance of a Laplacian operator, or any other methods of blur detection known by those having ordinary skill in the art. In addition, or alternatively, the image processing algorithms may use other suitable techniques for recognizing or identifying items or objects, such as edge matching or detection, divide-and-conquer searching, greyscale matching, histograms of receptive field responses, or another suitable routine (e.g., executed at the controller 120 based on one or more captured images from one or more cameras). Other image processing techniques are possible and within the scope of the present subject matter. The processing algorithm may further include measures for isolating or eliminating noise in the image comparison, e.g., due to image resolution, data transmission errors, inconsistent lighting, or other imaging errors. By eliminating such noise, the image processing algorithms may improve accurate object detection, avoid erroneous object detection, and isolate the important object, region, or pattern within an image.

In addition to the image processing techniques described above, the image analysis may include utilizing artificial intelligence (“AI”), such as a machine learning image recognition process, a neural network classification module, any other suitable artificial intelligence (AI) technique, and/or any other suitable image analysis techniques, examples of which will be described in more detail below. Moreover, each of the exemplary image analysis or evaluation processes described below may be used independently, collectively, or interchangeably to extract detailed information regarding the images being analyzed to facilitate performance of one or more methods described herein or to otherwise improve appliance operation. According to exemplary embodiments, any suitable number and combination of image processing, image recognition, or other image analysis techniques may be used to obtain an accurate analysis of the obtained images.

In this regard, the image recognition process may use any suitable artificial intelligence technique, for example, any suitable machine learning technique, or for example, any suitable deep learning technique. According to an exemplary embodiment, the image recognition process may include the implementation of a form of image recognition called region based convolutional neural network (“R-CNN”) image recognition. Generally speaking, R-CNN may include taking an input image and extracting region proposals that include a potential object or region of an image. In this regard, a “region proposal” may be one or more regions in an image that could belong to a particular object or may include adjacent regions that share common pixel characteristics. A convolutional neural network is then used to compute features from the region proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like, as opposed to a regular R-CNN architecture. For example, mask R-CNN may be based on fast R-CNN which is slightly different than R-CNN. For example, R-CNN first applies a convolutional neural network (“CNN”) and then allocates it to zone recommendations on the covn5 property map instead of the initially split into zone recommendations. In addition, according to exemplary embodiments, standard CNN may be used to obtain, identify, or detect any other qualitative or quantitative data related to one or more objects or regions within the one or more images. In addition, a K-means algorithm may be used.

According to still other embodiments, the image recognition process may use any other suitable neural network process while remaining within the scope of the present subject matter. For example, the step of analyzing the one or more images may include using a deep belief network (“DBN”) image recognition process. A DBN image recognition process may generally include stacking many individual unsupervised networks that use each network’s hidden layer as the input for the next layer. According to still other embodiments, the step of analyzing one or more images may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence analysis techniques, and combinations of the above described or other known methods may be used while remaining within the scope of the present subject matter.

In addition, it should be appreciated that various transfer techniques may be used but use of such techniques is not required. If using transfer techniques learning, a neural network architecture may be pretrained such as VGG16 / VGG19 / ResNet50 with a public dataset then the last layer may be retrained with an appliance specific dataset. In addition, or alternatively, the image recognition process may include detection of certain conditions based on comparison of initial conditions, may rely on image subtraction techniques, image stacking techniques, image concatenation, etc. For example, the subtracted image may be used to train a neural network with multiple classes for future comparison and image classification.

It should be appreciated that the machine learning image recognition models may be actively trained by the appliance with new images, may be supplied with training data from the manufacturer or from another remote source, or may be trained in any other suitable manner. For example, according to exemplary embodiments, this image recognition process relies at least in part on a neural network trained with a plurality of images of the appliance in different configurations, experiencing different conditions, or being interacted with in different manners. This training data may be stored locally or remotely and may be communicated to a remote server for training other appliances and models. According to exemplary embodiments, it should be appreciated that the machine learning models may include supervised and/or unsupervised models and methods. In this regard, for example, supervised machine learning methods (e.g., such as targeted machine learning) may help identify problems, anomalies, or other occurrences which have been identified and trained into the model. By contrast, unsupervised machine learning methods may be used to detect clusters of potential failures, similarities among data, event patterns, abnormal concentrations of a phenomenon, etc.

It should be appreciated that image processing and machine learning image recognition processes may be used together to facilitate improved image analysis, object detection, or to extract other useful qualitative or quantitative data or information from the one or more images that may be used to improve the operation or performance of the appliance. Indeed, the methods described herein may use any or all of these techniques interchangeably to improve image analysis process and facilitate improved appliance performance and consumer satisfaction. The image processing algorithms and machine learning image recognition processes described herein are only exemplary and are not intended to limit the scope of the present subject matter in any manner.

The image analysis techniques described above may be used to determine that that the user is facing or approaching the appliance, which may be indicative of a desire to interact with the appliance. In this regard, step 230 may include determining that the user wishes to interact with the appliance based at least in part on the proximity or the posture of the user. For example, determining that the user is within a predetermined proximity of the appliance may include calculating a number of pixels in the one or more images that show the user. The number of pixels may be used to assess proximity, e.g., with more pixels indicating that the user is closer to the appliance and fewer pixels indicating that the user is farther away. In addition, or alternatively, determining that the user is within the predetermined proximity of the appliance may include approximating the height of the user based on the one or more images.

Step 240 may include adjusting interaction parameters of the appliance in response to determining that the user wishes to interact with the appliance. In this regard, standard interaction parameters may require the use of a wake word or direct interaction with the user interface or a remote software application to perform enhanced operating features. By contrast, when the proximity or posture of the user indicates a desire to interact with the appliance, enhanced interaction parameters may be activated. In this regard, these enhance interaction parameters may include initiating a voice interaction module of the appliance, permitting voice-activated dispensing, opening or unlatching a door of the appliance, etc. It should be appreciated that any other suitable adjustments to the interaction parameters of the appliance may be used while remaining within the scope of the present subject matter.

FIG. 3 depicts an example control method having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of these methods are explained using refrigerator appliance 100 as an example, it should be appreciated that these methods may be applied to the operation of any suitable appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An appliance comprising:
a cabinet;
a camera; and
a controller in operative communication with the camera, the controller being configured to:
obtain one or more images using the camera;
analyze the one or more images to identify a proximity or posture of a user;
determine that the user wishes to interact with the appliance based at least in part on the proximity or the posture of the user; and
adjust interaction parameters of the appliance in response to determining that the user wishes to interact with the appliance.

2. The appliance of claim 1, wherein analyzing the one or more images to identify the proximity or the posture of the user comprises:
performing a background subtraction algorithm to isolate the user in the one or more images.

3. The appliance of claim 1, wherein analyzing the one or more images to identify the proximity or the posture of the user comprises:
distinguishing between a static environment and movement of the user.

4. The appliance of claim 1, wherein analyzing the one or more images to identify the proximity or the posture of the user comprises:
determining that the user is facing or approaching the appliance.

5. The appliance of claim 1, wherein analyzing the one or more images to identify the proximity or the posture of the user comprises:
determining that the user is within a predetermined proximity of the appliance.

6. The appliance of claim 5, wherein determining that the user is within the predetermined proximity of the appliance comprises:
calculating a number of pixels in the one or more images that show the user.

7. The appliance of claim 5, wherein determining that the user is within the predetermined proximity of the appliance comprises:
approximating a height of the user based on the one or more images.

8. The appliance of claim 1, wherein adjusting the interaction parameters of the appliance comprises:
initiating a voice interaction module of the appliance.

9. The appliance of claim 1, wherein adjusting the interaction parameters of the appliance comprises:
permitting voice-activated dispensing.

10. The appliance of claim 1, wherein adjusting the interaction parameters of the appliance comprises:
opening a door of the appliance.

11. The appliance of claim 1, wherein the camera is mounted on a door of the appliance.

12. The appliance of claim 1, wherein the appliance is a refrigerator appliance.

13. A method of operating an appliance, the appliance comprising a cabinet and a camera, the method comprising:
obtaining one or more images using the camera;
analyzing the one or more images to identify a proximity or posture of a user;
determining that the user wishes to interact with the appliance based at least in part on the proximity or the posture of the user; and
adjusting interaction parameters of the appliance in response to determining that the user wishes to interact with the appliance.

14. The method of claim 13, wherein analyzing the one or more images to identify the proximity or the posture of the user comprises:
performing a background subtraction algorithm to isolate the user in the one or more images.

15. The method of claim 13, wherein analyzing the one or more images to identify the proximity or the posture of the user comprises:
distinguishing between a static environment and movement of the user.

16. The method of claim 13, wherein analyzing the one or more images to identify the proximity or the posture of the user comprises:
determining that the user is facing or approaching the appliance.

17. The method of claim 13, wherein analyzing the one or more images to identify the proximity or the posture of the user comprises:
determining that the user is within a predetermined proximity of the appliance.

18. The method of claim 13, wherein adjusting the interaction parameters of the appliance comprises:
initiating a voice interaction module of the appliance.

19. The method of claim 13, wherein adjusting the interaction parameters of the appliance comprises:
permitting voice-activated dispensing.

20. The method of claim 13, wherein adjusting the interaction parameters of the appliance comprises:
opening a door of the appliance.
